(19) United States
(12) Patent Application Publication
(10) Pub. No.: US 2018/0302559 A1
(43) Pub. Date: Oct. 18, 2018

(54) FAST ACTIVATING VIDEO CAMERA WITH SOLAR SUPPLEMENTED CHARGING

(71) Applicant: Chi Yuen Lee, Tai Po (HK)

(72) Inventor: Chi Yuen Lee, Tai Po (HK)

(21) Appl. No.: 15/490,781

(22) Filed: Apr. 18, 2017

(51) Int. Cl. H04N 5/232; H04N 7/18; G08B 13/19; H02J 7/35

(52) U.S. Cl. CPC H04N 5/23241; H02J 7/355; G08B 13/19; H04N 7/188

(57) ABSTRACT

A video camera system is disclosed which provides fast activation time with extended power life. The video camera system initializes the set-up of a processor and an image capture device. Once initialized, the image capture device and processor are placed into sleep/standby modes to conserve energy from a battery. In response to an object triggering a motion detector, the pre-initialized image capture device and processor are awaken to immediately begin video recording. As power is consumed during the video recording process, the battery supply is replenished by a solar panel connected to the camera.

### BACKGROUND

The embodiments herein relate generally to video cameras, and more particularly to a fast activating video camera with solar supplemented charging.

Many conventional video cameras are slow to activate and record once turned on. Many cameras have automatic detection of objects within an area which triggers operation. Typically the image capture device and processor are off and do not initialize setup operations until detection is triggered. Once detection is triggered, initialization and setup begin which takes power and time to finalize before recording begins. While solar powered video surveillance cameras exist, the power system designs contribute to the slow operation because there is limited energy available to power the detection, initialization, and active recording functions. As a result, video capture of moving objects may be lost due to the lag at video startup. As may be seen, there is a need for a video camera system that activates quickly enough to capture video once movement/presence is detected.

### SUMMARY

According to one embodiment, a camera system comprises an image capture device; a battery module connected to and powering the image capture device; a solar panel electrically connected to the battery module to recharge the battery module; a motion detector; and a processor connected to the motion detector and the image capture device, wherein the processor maintains the image capture device pre-initialized and in a sleep mode until a signal is registered from the motion detector and in response to the registered signal from the motion detector, the processor starts video capture by the pre-initialized image capture device.

In another aspect, a method of operating a video camera comprises initializing set-up of an image capture device and a processor connected to the image capture device in the camera; placing the initialized image capture device and the processor on standby mode; registering a signal from a motion detector connected to the processor; waking up the initialized image capture device and the processor from stand-by mode to immediately begin video capture with the image capture device.

### BRIEF DESCRIPTION OF THE FIGURES

The detailed description of some embodiments of the present invention is made below with reference to the accompanying figures, wherein like numerals represent corresponding parts of the figures.

FIG. 1 is a perspective front view of a solar powered camera in accordance with an exemplary embodiment of the present invention;

FIG. 2 is a cross-sectional side of the camera view taken along 2-2 of FIG. 1;

FIG. 3 is a cross-sectional side of the camera view taken along 3-3 of FIG. 1;

FIG. 4 is a block diagram of showing connections between electronic components in a solar powered camera in accordance with an exemplary embodiment of the present invention;

FIG. 5 is a block diagram of receiver unit that is wirelessly connected to the solar powered camera of FIG. 1 which in turn is bridged to the internet network in accordance with an exemplary embodiment of the present invention;

FIG. 6 is a flowchart for a process of activating a solar powered video camera. In accordance with an exemplary embodiment of the present invention; and

FIG. 7 is a perspective front view of a solar powered camera system in accordance with another exemplary embodiment of the present invention.

### DETAILED DESCRIPTION OF CERTAIN EMBODIMENTS

In general, embodiments of the subject technology provide a fast activating video camera running on a hybrid battery and solar powered power source. The combination of battery power and solar power allows the system control to activate recording quickly while replenishing the battery supply by solar charging when power is drawn. Thus, there is no fear of draining the battery. During the daytime, the battery is continuously being replenished so that fast recording activation is easily achieved without power drain to the system. At nighttime, the battery module is sufficiently large to handle many instances of recording and can thereafter be powered back up during the day in a worst case scenario.

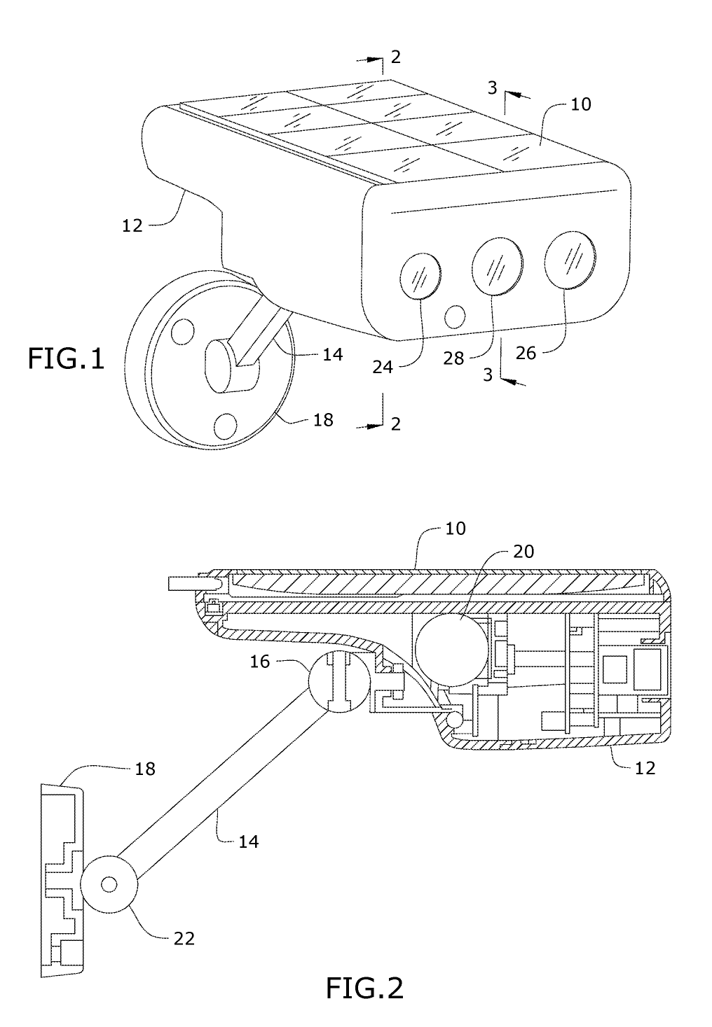

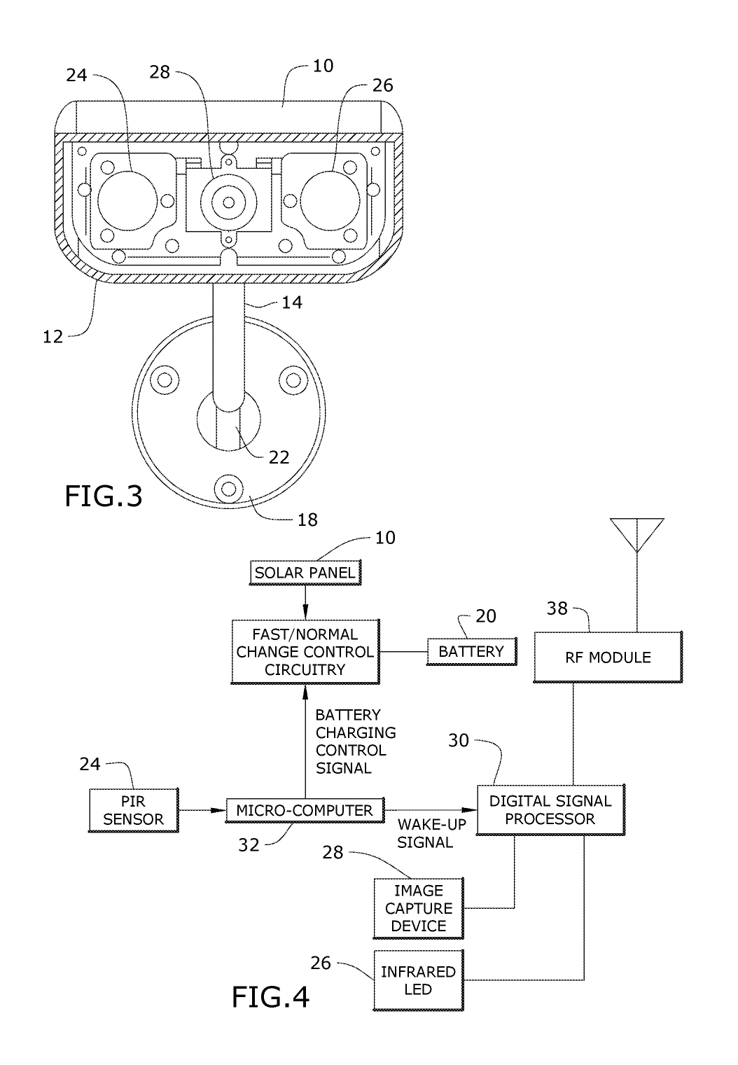

Referring now to FIGS. 1-4, a solar powered video camera is shown according to an exemplary embodiment. The video camera generally includes a main unit housing 12 onto which a solar panel 10 is mounted and connected, generally from one or more surfaces that will face sunlight (for example, a roof of the housing 12 as shown). In addition, a battery module 20 is housed that directly powers the electrical components described herein. In an exemplary embodiment, the camera includes a passive infrared (PIR) sensor 24, an infrared (IR) LED 26, and an image capture device 28 powered by the battery module 20. The camera may also include a micro-computer 32 controlling signals from the PIR sensor 24 to a digital signal processor (DSP) 30 which in turn may be connected to the IR LED 26 and image capture device 28. In some embodiments, a radio frequency (RF) module 38 may be connected to the DSP 30 for wireless communication. For example, as will be described further below, some embodiments include a receiver unit which communicates with the camera through the RF module 38. In an exemplary embodiment, charge control circuitry may be included and controlled by the micro-computer 32 which controls the recharge speed of the battery module 20 based on the load requirements of the camera in or after operation.

As shown the camera may be wall mountable however other embodiments may be mounted in other areas. In the embodiment shown, the camera includes a mounting arm 14 coupling the housing 12 to a mounting bracket 18. Some embodiments may include a hinge 16 at a proximal end of the arm 14 to pivot the housing 12 as desired. A bracket hinge 22 may be included at a distal end of the arm 14 to pivot the arm 14 from the bracket 18 as desired.

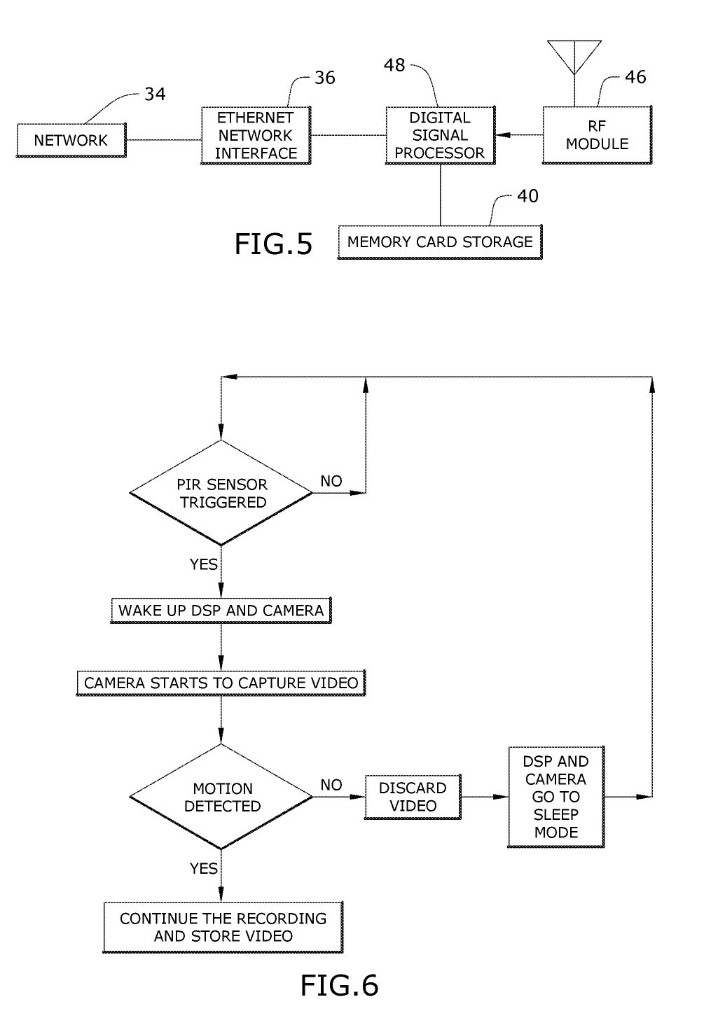

Referring now to FIG. 5, a wireless receiver unit for receiving data from the camera is shown according to an exemplary embodiment. The communications system includes a DSP 48 receiving wireless data transmission through a RF module 46. The RF module 46 may be configured to communicate with the RF module 38 (FIG. 4) of the camera. Data captured by the camera's recording may be processed by the DSP 48 and stored onto a memory storage card 40 connected to the DSP 48. The receiver unit may be connected to a network 34 through an Ethernet network interface 36 (on/in the camera). The network 34 may be a local area network, a wide area network, a telephony based network, or the Internet. A user may access audio/video data in the storage card 40 via the network 34 through the Ethernet network interface 36 and DSP 48.

Reference to operation of embodiments is described with respect to FIGS. 1-5 above and FIG. 6 which shows an exemplary process for video capture and operation of the camera described above. The camera is powered by the electrical energy stored in the internal battery module 20. The battery module 20 is rechargeable which is charged up by the energy converted from light energy collected by solar panel 10. As will be appreciated, the camera unit is self-sufficient and it becomes unnecessary to draw power from an electrical outlet if desired. At power-up, all the components are initialized and setup. Most electrical components (except for the PIR sensor 24) may enter sleep mode or standby mode if there is no object movement detected. This configuration enables a very fast response of the system to object movement detected by the PIR sensor 24 (as detected within an area illuminated by the IR LED 26) with very little power consumption while in standby mode. Whenever a valid object motion is detected within the detection range of the PIR sensor 24, the PIR sensor 24 will inform the microcomputer 32 to wake up the DSP 30 from sleep/standby and trigger the image capture device 28 to initiate recording. Since the DSP 30 and image capture device 28 are already initialized and setup, they will start the image capture process and signal conditioning immediately with fast response time. The DSP 30, after waken up, will perform second level software motion detection process and immediately store the audio/video signal in its buffer memory. In parallel, the RF module 38 of the camera is connecting with the RF module 46 of the receiver unit. After the RF link is set up, the audio/video signals stored in DSP 30's buffer memory will be transmitted sequentially (starting from the beginning of recording) to the receiver via RF module 38. Via RF module 46 the signal may be stored in memory card 40. In comparison to other available devices, audio/video signal capture and recording in the camera is independent of the RF link-up mechanism between the camera and receiver, which time is variable and dependent on the environment (such as physical distance and Wi-Fi interference). On the other hand, the wake-up-to-recording time in the camera does not depend on the external environment, and can be consistently very fast. As will be appreciated, this parallel mechanism minimizes the time lag from the occurrence of motion to the audio/video recording.

With respect to supplying power to the camera, the solar panel 10 collects the light energy and converts it to electrical energy. This electrical energy is fed to the charge control circuit which is regulated to charge up the battery module 20. The charging speed is controlled by the micro-computer 32 which may have for example, two modes; normal charging speed and fast charging speed. The fast charging speed may be invoked in response to extended or frequent video capture sessions to quickly replenish the battery module 20 to keep up with recording demands. The battery module 20 provides primary power to the whole system.

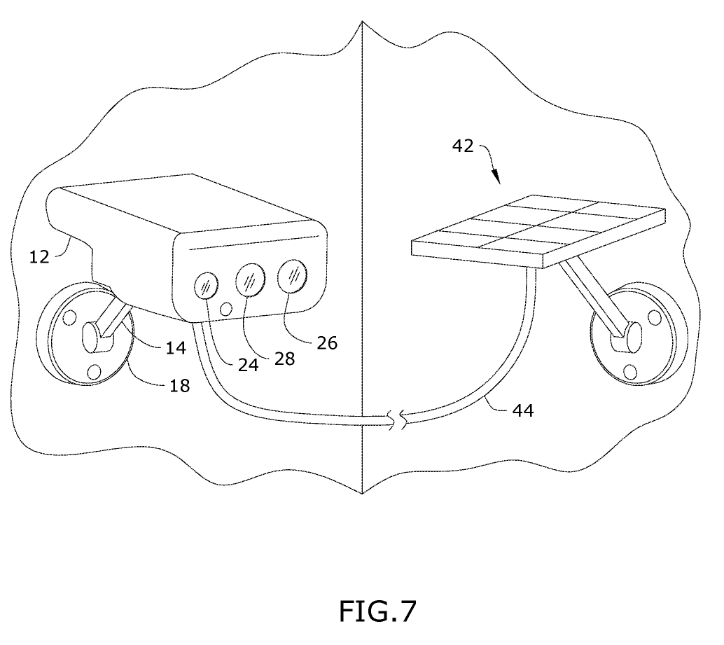

Persons of ordinary skill in the art may appreciate that numerous design configurations may be possible to enjoy the functional benefits of the inventive systems. For example, FIG. 7 shows an alternate embodiment of the camera that is similar to the camera of FIG. 1 except that a solar panel 42 is separate from the housing unit 12. Cable 44 electrically connects the solar panel 42 to the housing unit 12 so that solar powered energy can be generated for cameras mounted in shaded areas, yet will still function with the quick response and efficiency of cameras with an integrated solar panel 10 (FIG. 1). Thus, given the wide variety of configurations and arrangements of embodiments of the present invention the scope of the present invention is reflected by the breadth of the claims below rather than narrowed by the embodiments described above.

What is claimed is:

1. A camera system, comprising:
an image capture device;
a battery module connected to and powering the image capture device;
a solar panel electrically connected to the battery module to recharge the battery module;
a motion detector; and
a processor connected to the motion detector and the image capture device, wherein the processor maintains the image capture device pre-initialized and in a sleep mode until a signal is registered from the motion detector and in response to the registered signal from the motion detector, the processor starts video capture by the pre-initialized image capture device.

2. The camera system of claim 1, further comprising a micro-computer connected to the battery module and solar panel, the micro-computer configured to control charging speed of the battery module by the solar panel between a first charging speed and a second charging speed that charges faster than the first charging speed.

3. The camera system of claim 1, wherein the micro-computer is connected between the processor and the motion detector and wherein the processor is in a standby state until the micro-computer receives the registered signal from the motion detector and the micro-computer issues a wake-up call to the processor.

4. The camera system of claim 1, wherein the motion detector is a passive infra-red detector.

5. The camera system of claim 4, wherein a validation of object detection by the passive infra-red detector is run in parallel with the start of video capture by the pre-initialized image capture device.

6. A method of operating a video camera, comprising:
initializing set-up of an image capture device and a processor connected to the image capture device in the camera;
placing the initialized image capture device and the processor on standby mode;
registering a signal from a motion detector connected to the processor; and
waking up the initialized image capture device and the processor from stand-by mode to immediately begin video capture with the image capture device.

7. The method of claim 6, further comprising a validation of object detection by the motion detector run in parallel with the video capture by the initialized image capture device.

8. The method of claim 6, further comprising replenishing a battery module with solar generated electricity by a solar panel integrated into the camera as video capture is performed.

9. The method of claim 6, further comprising immediately storing a captured video signal in a buffer memory in response to the step of waking up the initialized image capture device and the processor from stand-by mode.
